(19) United States
(12) Patent Application Publication
(10) Pub. No.: US 2018/0322250 A1
(43) Pub. Date: Nov. 8, 2018

(54) AUTOMATED WORKFLOW RULES WITH LOCATION DATA

(71) Applicant: INTERNATIONAL BUSINESS MACHINES CORPORATION, Armonk, NY (US)

(72) Inventor: Murray Reicher, San Diego, CA (US)

(21) Appl. No.: 15/589,587

(22) Filed: May 8, 2017

(51) Int. Cl. G06F 19/00; G06N 3/02; H04W 4/02

(52) U.S. Cl. CPC G06F 19/324; H04W 4/02; G06N 3/02

(57) ABSTRACT

Location-aware medical image assignment is provided. In various embodiments, geolocation data of the user is received from a mobile device borne by the user. The user's availability to work based on the geolocation data or an indication by the user. A user profile of the user is read. One or more rules is applied to the user profile and the geolocation data to assign one or more medical imaging studies from a data store for review by the user.

### BACKGROUND

Embodiments of the present invention relate to assignment of medical imaging exams to appropriate healthcare workers, and more specifically, to automated workflow rules using location data such as that available through GPS.

### BRIEF SUMMARY

According to embodiments of the present disclosure, methods of and computer program products for location-aware medical image assignment are provided. In various embodiments, geolocation data of the user is received from a mobile device borne by the user. The user's availability to work based on the geolocation data or an indication by the user. A user profile of the user is read. One or more rules is applied to the user profile and the geolocation data to assign one or more medical imaging studies from a data store for review by the user.

### BRIEF DESCRIPTION OF THE SEVERAL VIEWS OF THE DRAWINGS

FIG. 1 depicts an exemplary Picture Archiving and Communication System.

FIG. 2 illustrates a system for location-aware medical image assignment according to embodiments of the present disclosure.

FIG. 3 illustrates a method for location-aware medical image assignment according to embodiments of the present disclosure.

FIG. 4 depicts a computing node according to an embodiment of the present invention.

### DETAILED DESCRIPTION

Assignment of medical imaging exams to appropriate healthcare workers is an important workflow step in medical imaging facilities such as ambulatory imaging centers, hospitals, and integrated healthcare delivery networks. Automated work assignment may, in various embodiments, focus on particular portions of the imaging workflow. For example, assignment may be based on pre-exam processes, such as checking for clinical or laboratory risk factors, assessment of imaging screening needs, appointment confirmation, or insurance eligibility checking. For example, assignment may focus on the reading and reporting of medical imaging exams by physicians, or may focus on other workflows, such as peer review or technical quality review. Assigning exams helps ensure that work is allocated fairly and to the proper healthcare worker.

Assignment using an electronic information system such as a radiology information system (RIS), cardiovascular information system (CVIS) or picture archive and communication system (PACS) generally involves manual intervention. Automated systems according to the present disclosure may allocate work based on configuration rules. Such configuration rules may require knowledge of the appropriate worker's availability or schedule.

The current disclosure provides approaches to work assignment based on configurable rules that filter available exams or visits into subsets called rotations, then assigns exams comprising one or more specific rotations based on rules governing which rotation(s) are appropriate for each user based the user's location, time of day, and day of the week. By employing this two-step of configuration, in which an administrator firstly creates rotations, then secondly, stores attributes for each user or user group (specifying which rotation is to be assigned automatically based on the user's location, day of week, and time of day), systems according to the present disclosure greatly simplify configuration of assignment rules. These approaches also enable systems to function without foreknowledge of the workers' schedules. Instead, when a particular worker become available to the system, as described below, the assignment engine assigns work as prescribed by the rules.

The present disclosure also provides means of tracking a user's availability using a global positioning (GPS) device or other location data. In some embodiments, for example, a physician employs a smartphone application to indicate that he or she is available to start working. Using the phone's GPS or other geolocation features, the system uploads the physician's location to a computer system that is used to complete the assigned task or that communicates with the computer system used to complete the assigned task. Based on the location, day of time and day of week, exams are assigned on the computer reading system (which, in one embodiment, is a PACS workstation at that location). Thus, even in the case of a browser-based PACS or PACS presented using a virtualized desktop technology, wherein the PACS may not be able to specifically identify the physician's location (and therefore the proper rotation) when the user logs onto the PACS, by using the phone-based GPS system, the rules engine will know which rotation to assign.

A Picture Archiving and Communication System (PACS) is a medical imaging system that provides storage and access to images from multiple modalities. In many healthcare environments, electronic images and reports are transmitted digitally via PACS, thus eliminating the need to manually file, retrieve, or transport film jackets. A standard format for PACS image storage and transfer is DICOM (Digital Imaging and Communications in Medicine). Non-image data, such as scanned documents, may be incorporated using various standard formats such as PDF (Portable Document Format) encapsulated in DICOM.

In various embodiments, the present disclosure employs deep learning and artificial intelligence to learn which rotations are appropriate for which workers depending on location, time of day, or day of the week based on tracking the user's behavior. For example, the system may analyze one or more of the exam description, imaging modality, information in the DICOM meta-file, patient demographics, location of where the exam was performed, the referring doctor, medical images, or other such data in order to assess a worker's customary behavior. Using this information about the user, or perhaps about an array of users, the system may modify the rules used to create rotations and to modify which rotation is assigned to a particular user. The system may even dynamically change the definition of a rotation or to whom it is assigned based on the volume of work that needs to be completed or due dates. Thus, the rules engine can be automatically refined over time using artificial intelligence and even image analytics, this reducing administrative burden. By analyzing characteristics that may correlate with other measures, such as the time a user requires to read an exam or the accuracy of the report, the rules engine may self-optimize to help produce more accurate, efficient outcomes.

In some embodiments, a phone application is provided that allows a user to schedule his or her availability, to initiate the assignment of exams, to be notified that a condition exists where he or she is needed to process exams, or to display information related to work activity. For example, the phone application may display a dashboard showing the user's productivity goals, pace of work, work produced relative to colleagues, or enable the user to obtain work unit credit for other activities. Thus, the phone app may make information available to a user without requiring display on a RIS, CVIS, or PACS, therefore reducing screen clutter on these other systems. The phone app may also be used to alert the user regarding urgent exams, messages from co-workers, expected end-of-shift, or work pace falling outside of specified boundaries.

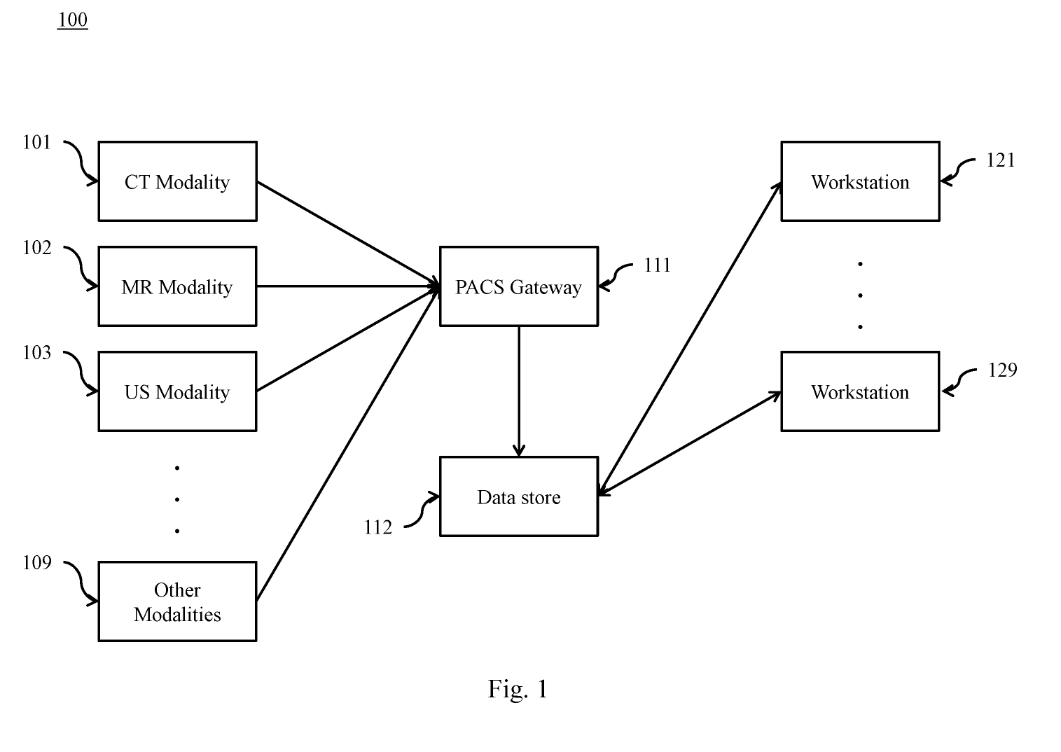

Referring to FIG. 1, an exemplary PACS 100 consists of four major components. Various imaging modalities 101 . . . 109 such as computed tomography (CT) 101, magnetic resonance imaging (MRI) 102, or ultrasound (US) 103 provide imagery to the system. In some implementations, imagery is transmitted to a PACS Gateway 111, before being stored in archive 112. Archive 112 provides for the storage and retrieval of images and reports. Workstations 121 . . . 129 provide for interpreting and reviewing images in archive 112. In some embodiments, a secured network is used for the transmission of patient information between the components of the system. In some embodiments, workstations 121 . . . 129 may be web-based viewers. PACS delivers timely and efficient access to images, interpretations, and related data, eliminating the drawbacks of traditional film-based image retrieval, distribution, and display.

A PACS may handle images from various medical imaging instruments, such as digitized radiographs (RG), ultrasound (US), magnetic resonance (MR), Nuclear Medicine imaging, positron emission tomography (PET), computed tomography (CT), endoscopy (ES), mammograms (MG), digital radiography (DR), computed radiography (CR), as well as visual light images related to histopathology, ophthalmology, dermatology, wound care, or surgery. A PACS is not limited to predetermined types of images, and supports clinical areas beyond conventional sources of imaging such as radiology, cardiology, oncology, or gastroenterology.

Different users may have a different view into the overall PACS system. For example, while a radiologist may typically access a viewing station, a technologist may typically access a QA workstation.

In some implementations, the PACS Gateway 111 comprises a quality assurance (QA) workstation. The QA workstation provides a checkpoint to make sure patient demographics are correct as well as other important attributes of a study. If the study information is correct the images are passed to the archive 112 for storage. The central storage device, archive 112, stores images and in some implementations, reports, measurements and other information that resides with the images.

Once images are stored to data store 112 (which in some embodiment may be referred to as an archive), they may be accessed from reading workstations 121 . . . 129. The reading workstation is where a reading physician reviews the patient's study and create a clinical report. In some implementations, a reporting application is integrated or interfaced with a reading workstation to enable the reading physician to create a clinical report. A variety of reporting systems may be integrated with the PACS, including those that rely upon traditional dictation. In some implementations, CD or DVD authoring software is included in workstations 121 . . . 129 to burn patient studies for distribution to patients or referring physicians.

In some implementations, a PACS includes web-based interfaces for workstations 121 . . . 129. Such web interfaces may be accessed via the internet or a Wide Area Network (WAN). In some implementations, connection security is provided by a VPN (Virtual Private Network) or SSL (Secure Sockets Layer). The client-side software may comprise ActiveX, JavaScript, or a Java Applet. PACS clients may also be full applications which utilize the full resources of the computer they are executing on outside of the web environment.

Communication within PACS is generally provided via Digital Imaging and Communications in Medicine (DICOM). DICOM provides a standard for handling, storing, printing, and transmitting information in medical imaging. It includes a file format definition and a network communications protocol. The communication protocol is an application protocol that uses TCP/IP to communicate between systems. DICOM files can be exchanged between two entities that are capable of receiving image and patient data in DICOM format.

DICOM groups information into data sets. For example, a file containing a particular image, generally contains a patient ID within the file, so that the image can never be separated from this information by mistake. A DICOM data object consists of a number of attributes, including items such as name and patient ID, as well as a special attribute containing the image pixel data. Thus, the main object has no header as such, but instead comprises a list of attributes, including the pixel data. A DICOM object containing pixel data may correspond to a single image, or may contain multiple frames, allowing storage of cine loops or other multi-frame data. DICOM supports three- or four-dimensional data encapsulated in a single DICOM object. Pixel data may be compressed using a variety of standards, including JPEG, Lossless JPEG, JPEG 2000, and Run-length encoding (RLE). LZW (zip) compression may be used for the whole data set or just the pixel data.

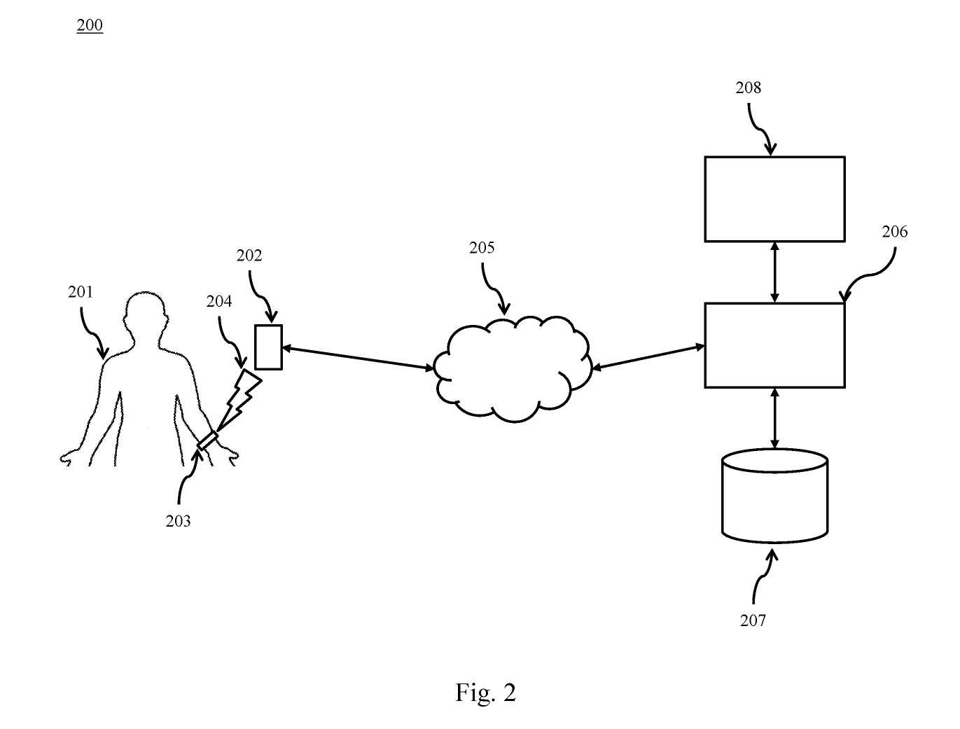

Referring now to FIG. 2, a system 200 for location-aware medical image assignment is illustrated according to embodiments of the present disclosure. A user 201 has access to a mobile device 202 including geolocation features such as GPS. In some embodiments, a wearable 203 including geolocation features is used in place of or in combination with mobile device 202. For example, wearable 203 may include a GPS receiver, and communicate location data to mobile device 202 via personal area network 204.

Location data for user 201 is transmitted over local area network (LAN) or wide area network (WAN) 205 from mobile device 202 to assignment system 206. In some embodiments, the LAN is a facility-specific network such as within a hospital. In some embodiments, the WAN is the internet. In some embodiments, the assignment system is integrated with a PACS system. In some embodiments, assignment system 206 stores location information for each of a plurality of users in data store 207.

In some embodiments, assignment system 206 reads one or more assignment rules from data store 207. Based on the location, time of day, day of week, and user attributes, the rules are applied to form a work assignment. Once an assignment is made, exams are made available on a reading system 208. In some embodiments, the reading system is a PACS workstation. However, in various other embodiments, the reading system comprises a web interface or virtual desktop. The reading system itself may not be dedicated to an individual user. In some cases, the reading system may be virtual, and thus its location varies between instantiations.

In some embodiments, assignment system 206 receives feedback from the user regarding selected exams to review. In this way, the assignment system may learn from a given user and refine its assignment rules according to user preferences. It will be appreciated that various deep learning techniques are suitable for use according to the present disclosure, including various artificial neural networks.

Suitable artificial neural networks include but are not limited to a feedforward neural network, a radial basis function network, a self-organizing map, learning vector quantization, a recurrent neural network, a Hopfield network, a Boltzmann machine, an echo state network, long short term memory, a bi-directional recurrent neural network, a hierarchical recurrent neural network, a stochastic neural network, a modular neural network, an associative neural network, a deep neural network, a deep belief network, a convolutional neural networks, a convolutional deep belief network, a large memory storage and retrieval neural network, a deep Boltzmann machine, a deep stacking network, a tensor deep stacking network, a spike and slab restricted Boltzmann machine, a compound hierarchical-deep model, a deep coding network, a multilayer kernel machine, or a deep Q-network.

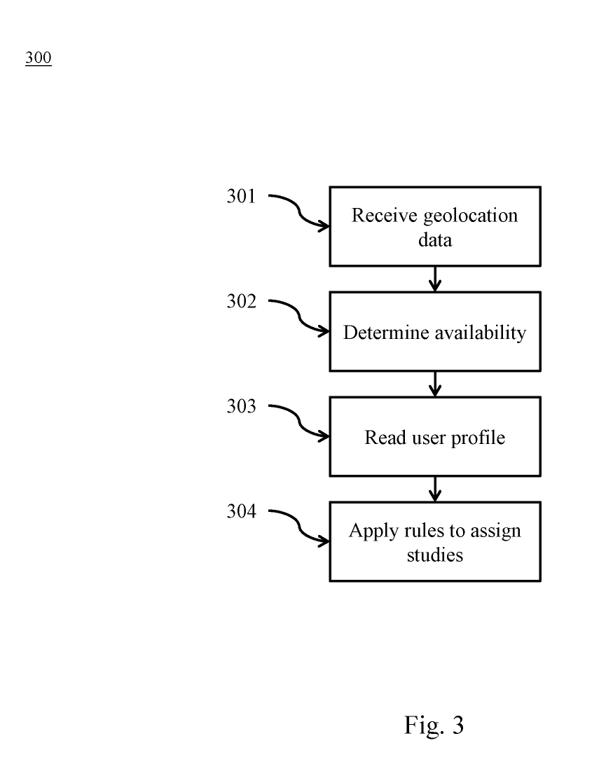

Referring now to FIG. 3, a method 300 for location-aware medical image assignment is illustrated according to embodiments of the present disclosure. At 301, geolocation data of the user is received from a mobile device borne by the user. At 302, the user's availability to work is determined based on the geolocation data or an indication by the user. At 303, a user profile of the user is read. At 304, one or more rule is applied to the user profile and the geolocation data to assign one or more medical imaging studies from a data store for review by the user.

In various embodiments, rules are generated or updated based on user activity. In some embodiments, user activity is monitored in real time, while in some embodiments user activity is determined from logs of prior activity. Such user activities may include a reader's behavior with regard to exams that are selected or deselected, or time spent reading a given exam. In some embodiments, user activity may be determined from a database of reports that a user has previously created (e.g., over the past year). Each report may have date and time stamps and location of service, thus providing the data necessary to apply machine learning techniques such as neural networks in order to generate or revise rules. In this way, rules may be generated for the rotation attributes of each user based on location, day of week, and time of day.

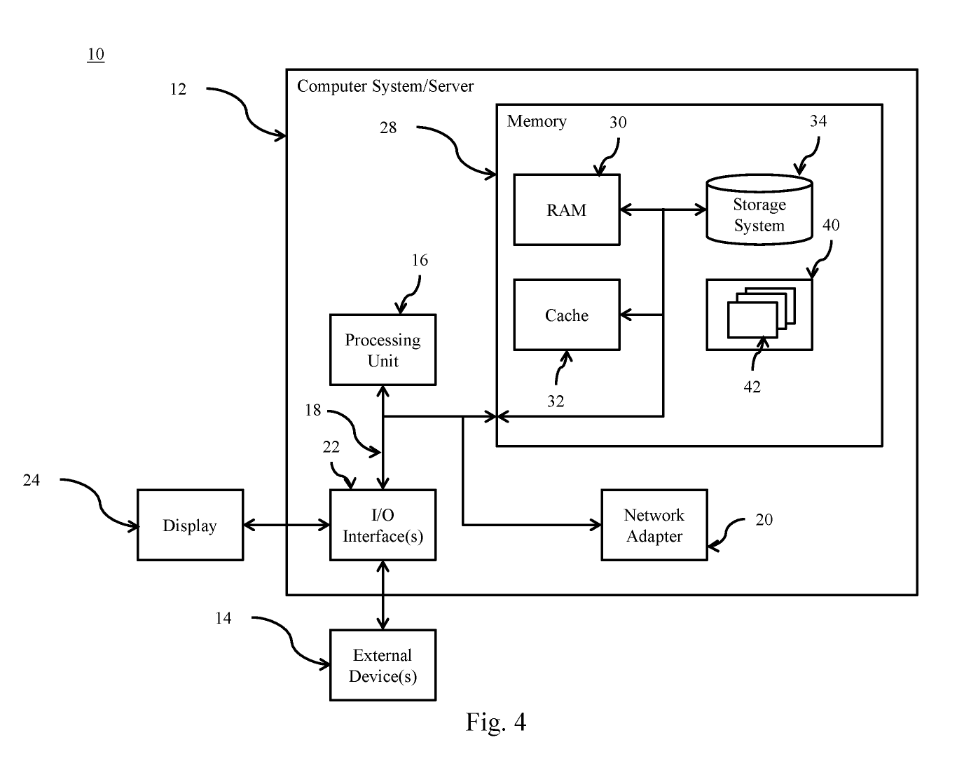

Referring now to FIG. 4, a schematic of an example of a computing node is shown. Computing node 10 is only one example of a suitable computing node and is not intended to suggest any limitation as to the scope of use or functionality of embodiments of the invention described herein. Regardless, computing node 10 is capable of being implemented and/or performing any of the functionality set forth hereinabove.

In computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 4, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
receiving geolocation data of the user from a mobile device borne by the user;
determining the user's availability to work based on the geolocation data or an indication by the user;
reading a user profile of the user;
applying one or more rules to the user profile and the geolocation data to assign one or more medical imaging studies from a data store for review by the user.

2. The method of claim 1, further comprising:
generating the one or more rules based on user activity.

3. The method of claim 2, wherein the user activity comprises selection of a medical imaging study, deselection of a medical imaging study, or viewing of a medical imaging study.

4. The method of claim 2, wherein generating the one or more rules comprises applying a neural network to the user activity.

5. The method of claim 1, wherein the indication by the user comprises a manual interaction with an application.

6. The method of claim 5, wherein the manual interaction comprises a login.

7. The method of claim 1, further comprising:
receiving from the user a selection from among the one or more medical imaging studies;
updating the one or more rules based on the selection.

8. The method of claim 2, wherein said updating comprises applying a neural network.

9. The method of claim 1, wherein the one or more rules are configurable.

10. The method of claim 1, wherein the user profile includes a specialty.

11. The method of claim 1, wherein the geolocation data of the user is determined from a GPS receiver of the mobile device.

12. The method of claim 1, further comprising:
providing the one or more medical imaging studies to a reader for review of the user.

13. The method of claim 1, wherein said assigning is based on a time of assignment.

14. The method of claim 1, wherein said assigning is based on metadata of the one or more medical imaging studies.

15. A system comprising:
a data store;
a computing node comprising a computer readable storage medium having program instructions embodied therewith, the program instructions executable by a processor to cause the processor to perform a method comprising:
receiving geolocation data of the user from a mobile device borne by the user;
determining the user's availability to work based on the geolocation data or an indication by the user;
reading a user profile of the user;
applying one or more rules to the user profile and the geolocation data to assign one or more medical imaging studies from the data store for review by the user.

16. The system of claim 15, the method further comprising:
generating the one or more rules based on user activity.

17. The system of claim 16, wherein the user activity comprises selection of a medical imaging study, deselection of a medical imaging study, or viewing of a medical imaging study.

18. The system of claim 16, wherein generating the one or more rules comprises applying a neural network to the user activity.

19. A computer program product for location-aware medical image assignment, the computer program product comprising a computer readable storage medium having program instructions embodied therewith, the program instructions executable by a processor to cause the processor to perform a method comprising:
receiving geolocation data of the user from a mobile device borne by the user;
determining the user's availability to work based on the geolocation data or an indication by the user;
reading a user profile of the user;
applying one or more rules to the user profile and the geolocation data to assign one or more medical imaging studies from a data store for review by the user.

20. The computer program product of claim 19, the method further comprising:
generating the one or more rules based on user activity.
